(19) United States
(12) Patent Application Publication
(10) Pub. No.: US 2020/0292167 A1
(43) Pub. Date: Sep. 17, 2020

(54) COMBUSTION SYSTEM WITH WIDE TURNDOWN COAL BURNER

(71) Applicant: Schindler Combustion LLC, Fairfield, CT (US)

(72) Inventor: Ed Schindler, Fairfield, CT (US)

(21) Appl. No.: 16/818,615

(22) Filed: Mar. 13, 2020

Related U.S. Application Data
(60) Provisional application No. 62/818,496, filed on Mar. 14, 2019.

(51) Int. Cl. F23C 7/00; F23K 3/02; F23D 1/02; F23L 15/00; F23L 5/02; F23N 1/02; B01D 45/16

(52) U.S. Cl. CPC F23C 7/008; F23N 2227/02; F23K 3/02; F23D 1/02; F23L 15/00; F23L 5/02; F23N 1/027; B01D 45/16; F23K 2200/00; F23K 2203/008; F23D 2900/00003; F23D 2900/01001; F23D 2201/10; F23N 2221/08; F23C 7/004

(57) ABSTRACT

A combustion system for a coal fired furnace having a windbox includes a source of a mixture of pulverized coal and air, and a splitter that receives the mixture and splits it into first and second mixed streams. A first nozzle receives the first mixed stream and discharges it into the furnace. A separator receives the second mixed stream and separates it into an air stream and a coal rich stream. An air conduit connected between the separator and the source of the mixture causes at least some of the air stream to be fed back into the mixture. A second nozzle receives the coal rich stream and discharges it into the furnace. A third nozzle receives support air from the windbox and discharges it into the furnace in a combustion supporting relationship with respect to the coal rich stream.

### FIELD OF THE INVENTION

The present invention relates to a combustion system and method for a coal-fired furnace and, more particularly, to such a system and method which utilizes coal as the primary fuel and combusts a coal-air mixture.

### BACKGROUND OF THE INVENTION

In a typical coal-fired furnace, particulate coal is delivered in suspension with primary air from a pulverizer, or mill, to the coal burners, or nozzles, and secondary air is provided to supply a sufficient amount of air to support combustion. After initial ignition, the coal continues to burn due to local recirculation of the gases and flame from the combustion process.

In these types of arrangements, the coal readily burns after the furnace has been operating over a fairly long period of time. However, for providing ignition flame during startup and for warming up the furnace walls, the convection surfaces and the air preheater, the mixture of primary air and coal from conventional main nozzles is usually too lean and is not conducive to burning under these relatively cold circumstances. Therefore, it had been the common practice to provide oil or gas fired ignitors and/or guns for warming up the furnace walls, convection surfaces and the air preheater, since these fuels have the advantage of a greater ease of ignition and, therefore, require less heat to initiate combustion. The ignitors were usually started by an electrical sparking device or swab, and the guns were usually lit by an ignitor or by a high energy or high tension electrical device.

Another application of auxiliary fuels to a coal-fired furnace was during reduced load conditions when the coal supply, and, therefore, the stability of the coal flame, was decreased. Under these conditions, the oil or gas ignitors and/or guns were used to maintain flame stability in the furnace and thus avoid accumulation of unburned coal dust in the furnace. This is also the case for poor quality fuels.

However, for various reasons, it became more and more undesirable to employ oil or gas fired warmup and low load guns. This situation was compounded by the ever-increasing change in operation of coal-fired nozzles from the traditional base-loaded mode to that of cycling, or shifting, modes which placed even heavier demands on supplemental oil and gas systems to support these types of units.

In view of the reduced desire to employ oil or gas fired warmup and low load guns, various alternatives have been employed with the aim of separating some of the air and coal exiting the mill or pulverizer so that localized coal rich areas can be created when desired (such as during warm-up and/or during reduced load conditions), but then allowing for more optimal coal/air mixtures to be used during normal operation. Examples of such alternatives include those disclosed in U.S. Pat. No. 4,412,496 to Trozzi entitled “Combustion System and Method for a Coal-Fired Furnace Utilizing a Low Load Coal Burner,” U.S. Pat. No. 4,497,263 to Vatsky et al. entitled “Combustion System and Method for a Coal-Fired Furnace Utilizing a Wide Turn-Down Burner” and U.S. Pat. No. 4,471,703 to Vatsky et al. entitled “Combustion System and Method for a Coal-Fired Furnace Utilizing a Louvered Low Load Separator-Nozzle Assembly and a Separate High Load Nozzle.” Each of U.S. Pat. Nos. 4,412,496, 4,497,263 and 4,471,703 is hereby incorporated by reference herein in its entirety.

The present invention is intended to improve upon the technologies disclosed in U.S. Pat. Nos. 4,412,496, 4,497,263 and 4,471,703.

### SUMMARY OF THE INVENTION

In accordance with one aspect of the present invention, a combustion system for a coal fired furnace having a windbox is provided. The combustion system includes a source of a mixture of pulverized coal and air, and a splitter in communication with the source, the splitter receiving the mixture and splitting the mixture into a first mixed stream and a second mixed stream. A first nozzle in communication with the splitter receives the first mixed stream and discharges the first mixed stream into the furnace. A separator in communication with the splitter receives the second mixed stream and separates the second mixed stream into an air stream and a coal rich stream. An air conduit connected between the separator and the source of the mixture causes at least some of the air stream to be fed back into the mixture. A second nozzle in communication with the separator receives the coal rich stream and discharges the coal rich stream into the furnace. A third nozzle in communication with the windbox of the furnace receives support air from the windbox and discharges the support air into the furnace in a combustion supporting relationship with respect to the coal rich stream.

In some embodiments, the first nozzle and the second nozzle are disposed in a coaxial relationship. In certain of these embodiments, the first nozzle extends around the second nozzle.

In some embodiments, the third nozzle comprises a plurality of conduits disposed around the second nozzle. In certain of these embodiments, the third nozzle comprises two conduits disposed on opposite sides of the second nozzle. In certain embodiments, each of the conduits has a generally triangular cross section.

In some embodiments, a longitudinal axis of the second nozzle is offset with respect to a longitudinal axis of the first nozzle. In certain of these embodiments, the third nozzle extends around the second nozzle and the third nozzle has a longitudinal axis that is coaxial with the longitudinal axis of the second nozzle.

In some embodiments, a plurality of vanes are provided for imparting a swirl to the first nozzle. In some embodiments, the separator comprises a cyclone separator.

In some embodiments, a support air conduit is connected between the separator and the third nozzle, the support air conduit causing at least some of the air stream to be mixed with the support air from the windbox and discharged into the furnace in a combustion supporting relationship with respect to the coal rich stream. In some embodiments, a heater is disposed between the third nozzle and the windbox of the furnace, the heater heating the support air from the windbox prior to the support air being discharged into the furnace.

In some embodiments, a fan is disposed between the third nozzle and the windbox of the furnace, the fan increasing a pressure of the support air from the windbox prior to the support air being discharged into the furnace. In some embodiments, the splitter includes a housing for receiving the mixture and a damper disposed in the housing for splitting the mixture into the first mixed stream and the second mixed stream, the damper being movable in the housing to control a quantity of the mixture diverted into each of the first mixed stream and the second mixed stream.

In accordance with another aspect of the invention, a method of operating a coal fired furnace having a windbox, comprises the steps of: (i) splitting a mixture of pulverized coal and air into a first mixed stream and a second mixed stream; (ii) passing the first mixed stream directly into the furnace through a first nozzle; (iii) separating the second mixed stream into an air stream and a coal rich stream; (iv) feeding at least some of the air stream back to the mixture of pulverized coal and air; (v) passing coal rich stream into the furnace through a second nozzle; and (vi) taking support air from the windbox of the furnace and discharging the support air into the furnace through a third nozzle in a combustion supporting relationship with respect to the coal rich stream.

In some embodiments, the method further comprises the step of igniting the coal rich stream during startup of the furnace. In some embodiments, the method further comprises the step of controlling a quantity of the mixture diverted into each of the first mixed stream and the second mixed stream. In some embodiments, the method further comprises the step of mixing at least some of the air stream with the support air from the windbox prior to the support air being discharged into the furnace.

In some embodiments, the method further comprises the step of heating the support air from the windbox prior to the support air being discharged into the furnace. In some embodiments, the method further comprises the step of increasing a pressure of the support air from the windbox prior to the support air being discharged into the furnace.

Other features and advantages of the invention will become more apparent from consideration of the following drawing.

### BRIEF DESCRIPTION OF THE DRAWINGS

FIG. 1 is a schematic diagram depicting the combustion system with a wide turndown coal burner of the present invention;

FIG. 2 is a plan view of a splitter utilized in connection with the combustion system of FIG. 1;

FIG. 3 is a partially cross-sectional view of the splitter taken along the line 3--3 of FIG. 2;

FIG. 4 is a fragmentary rear elevational view of an exemplary burner taken along the line 4--4 of FIG. 1;

FIG. 5 is a more detailed partially cross-sectional view of the burner portion of FIG. 1;

FIG. 6 is a fragmentary front elevational view of the burner taken along the line 6--6 of FIG. 5;

FIG. 7 is a schematic diagram depicting the combustion system of FIG. 1 incorporating additional optional features;

FIG. 8 is a more detailed partially cross-sectional view of the burner portion of FIG. 1, similar to FIG. 5, but with an alternate configuration of the nozzles; and

FIG. 9 is a fragmentary front elevational view of the burner taken along the line 9--9 of FIG. 8.

### DETAILED DESCRIPTION OF THE INVENTION

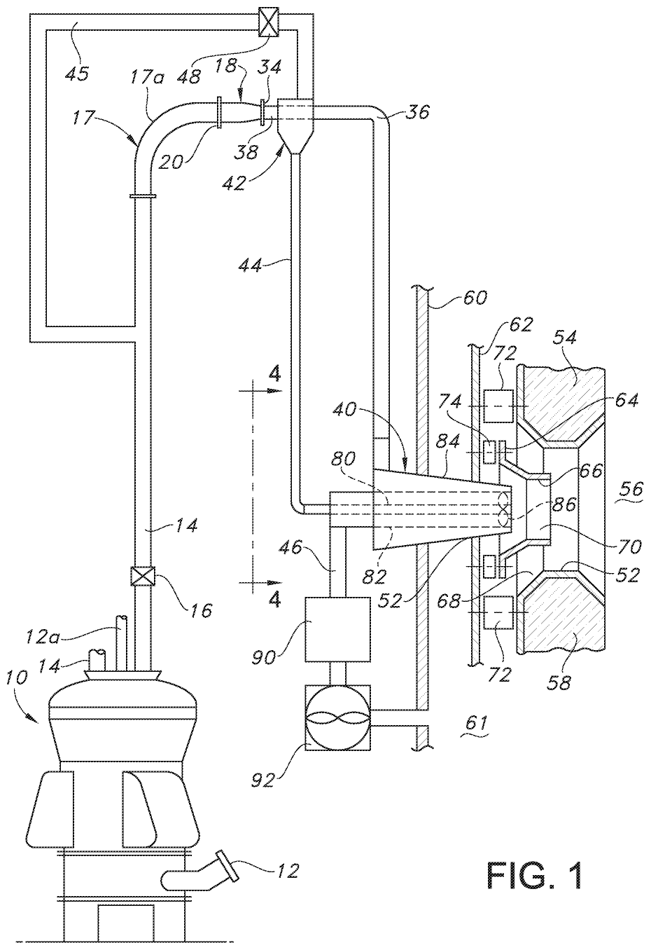

Referring first to FIG. 1 of the drawings, a coal mill (10), or pulverizer, has an inlet (12) for receiving air flow and an inlet (12a) for receiving raw coal flow, both of which are introduced into the mill under the control of a load control system (not shown). The mill (10) operates in a conventional manner to dry and grind the coal into relatively fine particles and has an outlet located in its upper portion which is connected to one end of a conduit (14) for receiving the mixture of pulverized coal and air. A shutoff valve (16) is provided in the conduit (14) and controls the flow of the coal/air mixture to an elbow (17) connected to the other end of the conduit and to a splitter (18) connected to the elbow (17). The elbow (17) has a rectangular cross-section and the coal is caused to move towards the outer portion (17a) of the turn of the elbow by centrifugal forces. Therefore, as the stream enters the splitter (18) the coal is essentially concentrated and spread out on the outer surface of the turn of elbow portion (17a).

It is understood that although only one conduit (14) is shown in detail in the interest of clarity, the mill (10) may have several outlets which connect to several conduits identical to conduit (14) which, in turn, are connected to several elbows (17) and splitters (18), with the number of outlets, conduits, elbows and splitters corresponding in number to the number of burners utilized in the particular furnace.

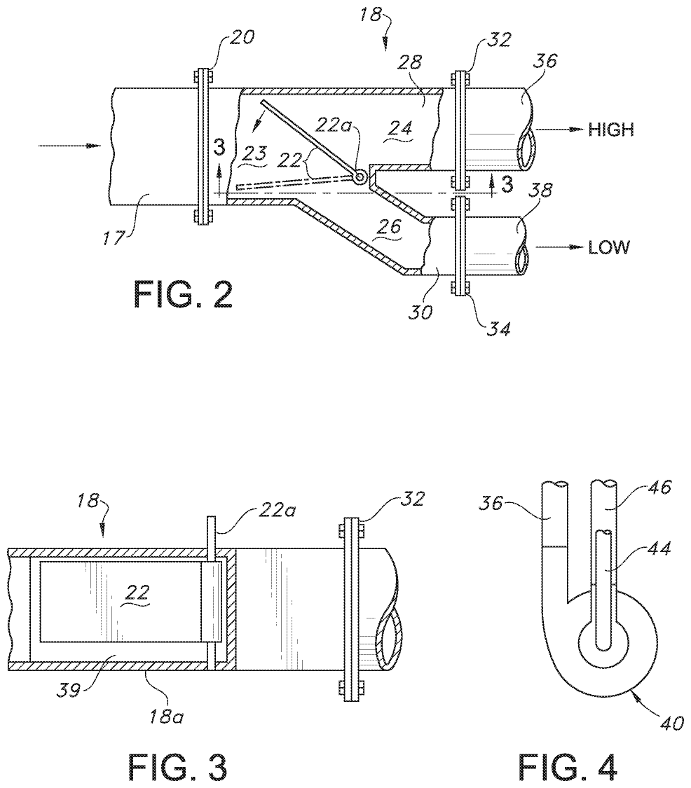

The splitter (18) is shown in detail in FIGS. 2 and 3 and includes a connecting flange (20) which connects to the end portion of the elbow (17). A damper (22) is provided in the interior of the splitter (18) and divides the splitter chamber (23) into a chamber (24) extending in line with the end portion of the elbow (17), and a chamber (26) extending immediately adjacent the chamber (24). The splitter (18) includes two outlets (28) and (30) which register with the chambers (24) and (26), and which are provided with connecting flanges (32) and (34), to connect them to two conduits (36) and (38), respectively. The damper (22) is pivotal about a shaft (22a) under the control of a control system (not shown) to vary the proportional flow rate between the chambers (24) and (26) and, therefore, the output to the conduits (36) and (38).

When the damper (22) is in the position shown by the solid lines in FIG. 2, most of the flow from the chamber (23) will be diverted into the chamber (26) and when the damper (22) is in the position as shown by the dashed lines, most of the flow from the chamber (23) will be directed into the chamber (24). Depending on the distance of the free end of the damper (22) to the side walls of the splitter (18), the quantity of flow to each of the chambers (24) and (26) can be controlled as required by the control system operating the shaft (22a).

The damper (22) is also designed and sized so that a gap (39) is formed between the damper's lower edge and the lower wall (18a) of the splitter, as shown in FIG. 3. This gap (39) permits some flow from the chamber (23) into the chamber (24) when the damper (22) is in the solid-line position and also permits some flow from the chamber (23) into the chamber (26) when the damper (22) is in the dashed line position. The combined effect of the rotation of the damper (22) and the presence of the gap (39) results in a division of the total air and coal flow into each of the chambers (24) and (26) at all loads in a proportion that produces the desired operational characteristics that will be described in detail later.

Referring again to FIG. 1, the conduit (38) is connected directly from the splitter (18) to a cyclone separator (42) and the conduit (36) extends from the splitter (18) to a burner nozzle assembly shown in general by the reference numeral (40). The cyclone separator (42) thus receives the mixture of pulverized coal and air from the conduit (38) and operates in a conventional manner to separate a large portion of air from the mixture. The separated coal, which contains relatively little air (e.g., on the order of 1%) is discharged into a low load, coal rich conduit (44) and the air is discharged into a vent air conduit (45). The conduit (44) is connected to the burner nozzle assembly (40) in a manner to be described in detail later. The conduit (45) is directed to re-introduce the primarily air stream back to the main air/coal stream being fed from the mill, for example, by being connected into conduit (14). A vent damper or valve (48) is provided in the conduit (45) for controlling the flow of air between conduits (44) and (45).

The burner nozzle assembly (40) is disposed in axial alignment with a through opening (52) formed in a front wall (54) of a conventional furnace forming, for example, a portion of a steam generator. It is understood that the furnace includes a back wall and a side wall of an appropriate configuration to define a combustion chamber (56) immediately adjacent the opening (52). The front wall (54), as well as the other walls of the furnace include an appropriate thermal insulation material (58) and, while not specifically shown, it is understood that the combustion chamber (56) can also be lined with boiler tubes through which a heat exchange fluid, such as water, is circulated in a conventional manner for the purposes of producing steam.

A vertical wall (60) is disposed in a parallel relationship with the furnace wall (54), and has an opening formed therein for receiving the burner nozzle assembly (40). It is understood that top, bottom, and side walls (not shown) are also provided which, together with the wall (60), form a plenum chamber or wind box (61), for receiving combustion supporting air, commonly referred to as “secondary air,” in a conventional manner.

An annular plate (62) extends around the burner (40) and between the front wall (54) and the wall (60). An additional annular plate (64) is provided between the plate (62) and the furnace wall (54) and extends in a spaced, parallel relation with the plate (62). An air divider sleeve (66) extends from the inner surface of the plate (64) and between the opening (52) and the burner (40) to define two air flow passages (68) and (70).

A plurality of outer register vanes (72) are pivotally mounted between the front wall (54) and the plate (62), to control the swirl of secondary air from the wind box (61) to the air flow passages (68) and (70). In a similar manner a plurality of inner register vanes (74) are pivotally mounted between the plates (62) and (64) to further regulate the swirl of the secondary air passing through the annular passage (70). It is understood that although only two register vanes (72) and (74) are shown in FIG. 1, several more vanes extend in a circumferentially spaced relation to the vanes shown. Also, the pivotal mounting of the vanes (72) and (74) may be done in any conventional manner, such as by mounting the vanes on shafts (shown schematically) and journalling the shafts in proper bearings formed in the front wall (54) and the plates (62) and (64). Also, the position of the vanes (72) and (74) may be adjustable by means of cranks or the like. Since these types of components are conventional, they are not shown in the drawings nor will they be described in any further detail. Other burner designs may be employed rather than this one with different arrangement of vanes to support combustion.

A hot air steam is taken from the windbox (61) and directed to the nozzle assembly (40) via a conduit (46). This hot air stream is used to increase the flame stability and work with a wider range of coals (including relatively lower quality coals). For added stability, wider coal use and to facilitate cold starting, the hot air stream is heated to as much as 1000° F. by way of a heater (90). The heater (90) may heat the hot air stream by way of electricity, natural gas, propane, oil, or any of other known methods.

To provide even better range of performance, the pressure of the hot air stream may be increased using a fan (92) or the like to allow it to operate at low loads, when the air pressure in the windbox (61) can be relatively low. For example, the fan (92) may be employed to boost the pressure of the hot air stream fed to the nozzle assembly (40) to 6 inches of water column (in WC).

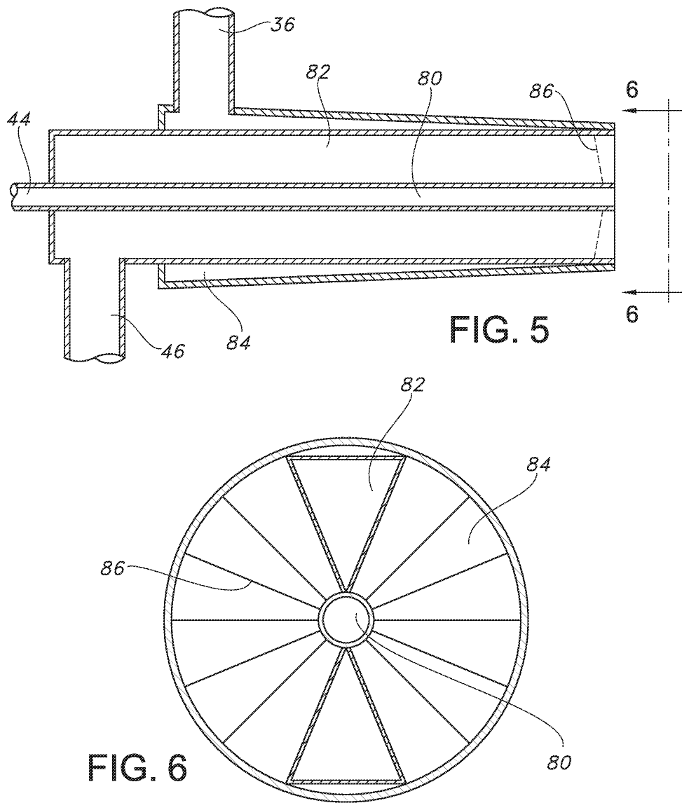

The burner nozzle assembly (40), which is illustrated in greater detail in FIGS. 5 and 6, includes at least one nozzle (80) which is connected to the conduit (44), at least one nozzle (82) which is connected to the conduit (46) and at least one nozzle (84) which is connected to the conduit (36). The at least one nozzle (80), which is illustrated as a single nozzle having a generally circular cross section (though such is not required) thus receives the dense phase particulate coal from the separator (42) and discharges it towards the opening (52) in the furnace wall (54).

The at least one nozzle (82) is disposed to discharge the hot air stream adjacent to the exit of nozzle (80) in a combustion supporting relation to the dense phase coal discharging from the nozzle (80). The at least one nozzle (82) may take the form of multiple conduits or pipes (two are shown in FIG. 6), which are disposed around the nozzle (80). As shown in FIG. 6, the conduits or pipes may have a generally triangular cross-section.

The outer nozzle (84) extends around the nozzle (80) in a generally coaxial relationship therewith and thus defines an annular passage—with the exception of the areas interrupted by the at least one nozzle (82)—which receives the mixture of air and coal from the splitter (18). The nozzle (84) is frustoconical in shape so that the passage between it and the coal nozzle (80) decreases in cross-section as the mixture of air and coal discharges from the nozzle (84).

A plurality of swirl vanes (86) are provided in the annular passage between the nozzle (80) and the nozzle (84) to impart a swirl to the coal/air mixture as it discharges into the opening (52). The vanes (86) can be of a conventional design and, as such, are tapered in a radially inward direction and are mounted in the annular passage between the nozzles (80) and (84) in a manner to permit them to impart a swirl to the coal/air mixture passing through the passage.

As better shown in FIG. 4, the connection between the conduit (36) and the nozzle (84) can be in a tangential direction so that a swirl is imparted to the air/coal mixture as it passes through the annular passage between the nozzles (80) and (84) before discharging towards the opening (52).

Although not shown in the drawings for the convenience of presentation, it is understood that various devices can be provided to produce ignition energy for a short period of time to the dense phase coal particles discharging from nozzle (80) to ignite the particles. For example, a high energy sparking device in the form of an arc ignitor or a small oil or gas conventional gun ignitor can be supported by the burner nozzle assembly (40).

Assuming the furnace discussed above forms a portion of a vapor generator and it is desired to start up the generator, the mill (10) begins receiving air flow and a small amount of coal flows through its inlets (12) and (12a), respectively, and operates to crush the coal into a predetermined fineness. The lean mixture of air and finely pulverized coal is discharged from the mill (10) where it passes into and through the conduit (14) and the valve (16), and through the elbow (17) into the chamber (23) of the splitter (18). Since, in its passage through the elbow (17) the coal tends to move to the outer surface (17a) of the elbow (17) as discussed above, a large portion of the mixture of coal and air entering the lower portion (as viewed in FIGS. 1 and 3) of the chamber (23) from the elbow (17) is air, while a large portion of the mixture entering the upper portion of the chamber (23) is coal.

As a result, and with the splitter damper (22) in the position shown by the solid lines in FIG. 2, the bulk of the coal plus a portion of the air is directed into the chamber (26) and into the conduit (38). Since the balance of the coal remaining in the chamber (23) is in the upper portion thereof, and the air in the lower portion, a relatively high quantity of air and a relatively low quantity of coal from the chamber (23) passes underneath the damper (22), through the gap (39) and into the chamber (24) by the static pressure caused by the resistance imposed by the sizing of the separator (42) and the components downstream of the separator (42). The air and coal carried into the chamber (24) in this manner will flow into and through the conduit (36) and to the nozzle (84).

The coal-air mixture passing through the chamber (26), which in accordance with the foregoing is most of the coal being pulverized at startup, passes into and through the conduit (38) and into the separator (42) where it is separated into dense phase particulate coal and air which are passed through the conduits (44) and (45) to the nozzle (80) and back to the supply conduit (14), respectively. At the same time, the hot air steam is taken from the windbox (61) and directed to the nozzles (82) via the conduit (46). For added stability, wider coal use and to facilitate cold starting, the hot air stream is heated to as much as 1000° F. by way of the heater (90), and the pressure of the hot air stream is increased using the fan (92).

The dense phase particulate coal from the nozzle (80) in combination with the hot air stream from the nozzle (82) is caused to intermix and recirculate in front of nozzles (80) and (82) resulting in a rich, heated mixture which can readily be ignited by one of the techniques previously described, such as, for example, directly from a high energy spark, or an oil or gas ignitor. Although the coal output of the mill (10) is low, the concentration of the fuel stream results in a rich mixture which is desirable and necessary at the point of ignition. The vortex so formed by this arrangement produces the desired recirculation of the products of combustion from the fuel being burned to provide the heat to ignite the new fuel as it enters the ignition zone.

The load on the unit can then be increased by placing more burners into service on the same mill (10) or by placing more mills into service in a similar fashion. When the desired number of mills and burners are in service and it is desired to further increase the load, the coal flow is increased to each mill. At the same time, the splitter damper (22) associated with each mill (10) is rotated towards the chamber (26) to cause some of the particulate coal which has concentrated in the upper portion of the splitter (18), along with a quantity of primary air, to be directed into the chamber (24) for passage, via the conduit (36) to the nozzle (84).

As the coal rate increases to full capacity, the splitter damper (22) continues to be rotated towards the chamber (26) until it reaches the position shown approximately by the dashed lines in FIG. 2.

In this position, a maximum flow of the coal/air mixture into the chamber (24) is achieved while some of the mixture passes through the gap (39) and past the splitter damper (22), through the chamber (26) and into the separator (42). By characterizing the motion of the splitter damper (22) with the mill output loading, the amount of coal and air going to the separator (42) and therefore to the low load nozzle (80) and can be kept at a low heat input value (approximately 5 to 20 percent of full load) while the main nozzle (84) will increase (or decrease) in loading as required. Sufficient turbulence is maintained by the low load nozzle (80) and the windbox air introduced through nozzles (82), although as load is increased the effect of the main registers and secondary air flow patterns will further aid in overall burner stability.

It is understood that the above arrangement may or may not require some preheated air depending on the moisture content of the fuel. If necessary, this heat can be provided by any of the conventional duct air heating techniques to increase the temperature of the primary air entering the mill (10).

Also, it is understood that the present invention is not limited to the specific burner and nozzle arrangement disclosed above but can be adapted to other configurations as long as the foregoing results are achieved. Also, various types of separators, other than cyclone separator discussed above, can be used within the scope of the invention.

Several advantages result from the foregoing. For example, the energy expenditures from the ignitor occurs only for the very short time needed to directly ignite the dense phase particulate coal from the nozzle (80), after which startup and warmup are completed solely by the combustion of the dense phase particulate coal as assisted by the heated and/or pressurized windbox air stream from the nozzle (82). Also, the dense phase particulate coal low load nozzle (80) stabilizes the main coal flame at wide load range conditions providing more flexibility of operation and less manipulation of auxiliary fuels. Further, the gap (39) provides a means to relieve the excess primary air flow into the conduits (36) and (45) which is not needed for combustion but needed for the pulverizer and its conduits, while at high load it permits some air and coal to flow into the low load system to maintain the burner flame.

The system and method described herein can be adapted to most existing systems and any new installation since the flow is divided in various paths and additional pressure losses are kept to a minimum.

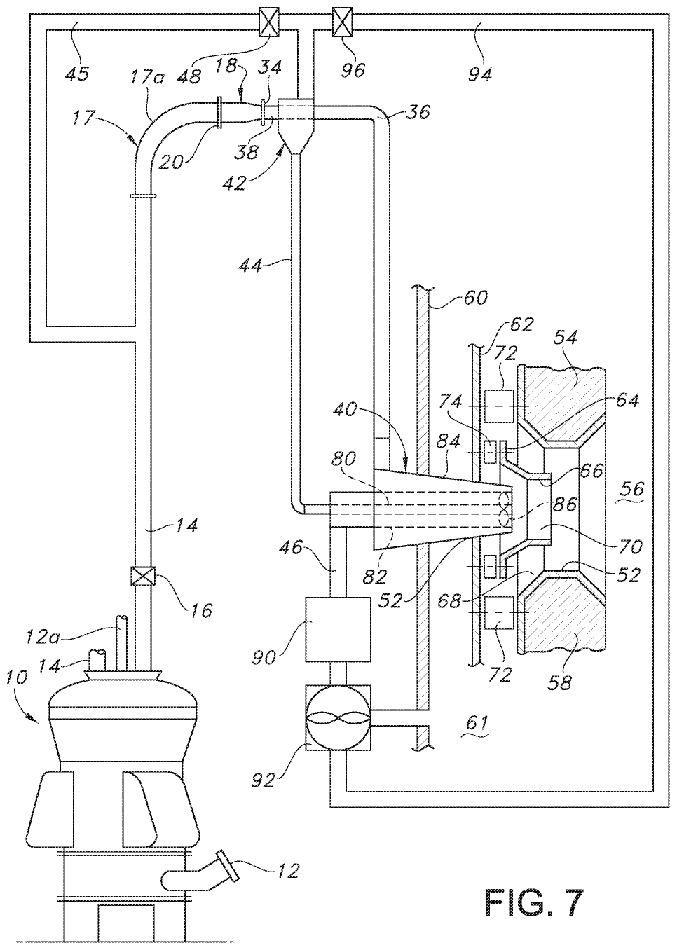

Turning now to FIG. 7, wherein like reference characters refer to like elements, it may be desirable to supplement the hot air steam taken from the windbox (61) and directed to the nozzles (82) via the conduit (46) with air taken from the separator (42). To this end, a conduit (94) may be provided to divert some of the separated air away from conduit (45) and feed it to mix with the hot air stream taken from the windbox (61). Another vent damper or valve (96) may be provided in the conduit (94) for controlling the flow of air between conduits (44), (45) and (94). In this manner, even more control may be exerted over the various flows of coal and air, and an even more robust, stable flame can be achieved.

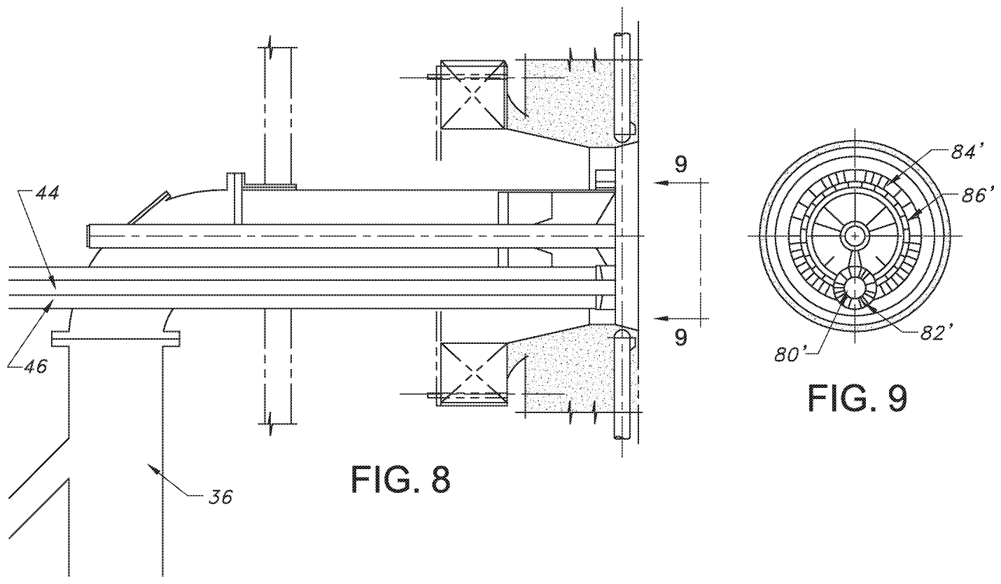

With respect now to FIGS. 8 and 9, an alternate burner configuration is shown, in which the relative positions of the nozzles is altered, as compared to the configuration shown in FIGS. 5 and 6. Specifically, rather than the dense phase coal nozzle (80) being coaxial with the main nozzle (84) which receives the mixture of air and coal from the splitter (18), as shown in FIGS. 5 and 6, in the alternate configuration shown in FIGS. 8 and 9, the dense phase coal nozzle (80′) is disposed to one side of the axis of the main nozzle (84′). Also, the hot air stream nozzle (82′) in this configuration is configured as a single conduit surrounding the dense phase coal nozzle (80′) so as to discharge the hot air stream adjacent to the exit of nozzle (80′) in a combustion supporting relationship. In other respects the structure and operation of the configuration shown in FIGS. 8 and 9 is similar to that shown in FIGS. 5 and 6, including the provision of swirl vanes (86′).

Although the invention has been described with reference to a particular arrangement of parts, features and the like, these are not intended to exhaust all possible arrangements or features, and indeed many other modifications and variations will be ascertainable to those of skill in the art.

What is claimed is:

1. A combustion system for a coal fired furnace having a windbox, said combustion system comprising:
a source of a mixture of pulverized coal and air;
a splitter in communication with said source, said splitter receiving the mixture and splitting the mixture into a first mixed stream and a second mixed stream;
a first nozzle in communication with said splitter, said first nozzle receiving the first mixed stream and discharging the first mixed stream into the furnace;
a separator in communication with said splitter, said separator receiving the second mixed stream and separating the second mixed stream into an air stream and a coal rich stream;
an air conduit connected between said separator and said source of the mixture, said conduit causing at least some of the air stream to be fed back into the mixture;
a second nozzle in communication with said separator, said second nozzle receiving the coal rich stream and discharging the coal rich stream into the furnace; and
a third nozzle in communication with the windbox of the furnace, said third nozzle receiving support air from the windbox and discharging the support air into the furnace in a combustion supporting relationship with respect to the coal rich stream.

2. The combustion system according to claim 1, wherein said first nozzle and said second nozzle are disposed in a coaxial relationship.

3. The combustion system according to claim 2, wherein said first nozzle extends around said second nozzle.

4. The combustion system according to claim 1, wherein said third nozzle comprises a plurality of conduits disposed around said second nozzle.

5. The combustion system according to claim 4, wherein said third nozzle comprises two conduits disposed on opposite sides of said second nozzle.

6. The combustion system according to claim 4, wherein each of the conduits has a generally triangular cross section.

7. The combustion system according to claim 1, wherein a longitudinal axis of said second nozzle is offset with respect to a longitudinal axis of said first nozzle.

8. The combustion system according to claim 7, wherein said third nozzle extends around said second nozzle and said third nozzle has a longitudinal axis that is coaxial with the longitudinal axis of said second nozzle.

9. The combustion system according to claim 1, further comprising a plurality of vanes for imparting a swirl to said first nozzle.

10. The combustion system according to claim 1, wherein said separator comprises a cyclone separator.

11. The combustion system according to claim 1, further comprising a support air conduit connected between said separator and said third nozzle, said support air conduit causing at least some of the air stream to be mixed with the support air from the windbox and discharged into the furnace in a combustion supporting relationship with respect to the coal rich stream.

12. The combustion system according to claim 1, further comprising a heater disposed between said third nozzle and the windbox of the furnace, said heater heating the support air from the windbox prior to the support air being discharged into the furnace.

13. The combustion system according to claim 1, further comprising a fan disposed between said third nozzle and the windbox of the furnace, said fan increasing a pressure of the support air from the windbox prior to the support air being discharged into the furnace.

14. The combustion system according to claim 1, wherein said splitter includes a housing for receiving the mixture and a damper disposed in the housing for splitting the mixture into the first mixed stream and the second mixed stream, the damper being movable in the housing to control a quantity of the mixture diverted into each of the first mixed stream and the second mixed stream.

15. A method of operating a coal fired furnace having a windbox, said method comprising the steps of:
splitting a mixture of pulverized coal and air into a first mixed stream and a second mixed stream;
passing the first mixed stream directly into the furnace through a first nozzle;
separating the second mixed stream into an air stream and a coal rich stream;
feeding at least some of the air stream back to the mixture of pulverized coal and air;
passing coal rich stream into said furnace through a second nozzle; and
taking support air from the windbox of the furnace and discharging the support air into the furnace through a third nozzle in a combustion supporting relationship with respect to the coal rich stream.

16. The method according to claim 15 further comprising the step of igniting the coal rich stream during startup of the furnace.

17. The method according to claim 15 further comprising the step of controlling a quantity of the mixture diverted into each of the first mixed stream and the second mixed stream.

18. The method according to claim 15 further comprising the step of mixing at least some of the air stream with the support air from the windbox prior to the support air being discharged into the furnace.

19. The method according to claim 15 further comprising the step of heating the support air from the windbox prior to the support air being discharged into the furnace.

20. The method according to claim 15 further comprising the step of increasing a pressure of the support air from the windbox prior to the support air being discharged into the furnace.
